(19) United States
(12) Patent Application Publication
(10) Pub. No.: US 2011/0268463 A1
(43) Pub. Date: Nov. 3, 2011

(54) IMAGE FORMING APPARATUS AND CLEANING METHOD

(75) Inventors: Takenobu KIMURA, Tokyo (JP); Junpei SHOUNO, Kawasaki-shi (JP)

(73) Assignee: KONICA MINOLTA BUSINESS TECHNOLOGIES, INC., Tokyo (JP)

(21) Appl. No.: 13/095,449

(22) Filed: Apr. 27, 2011

(30) Foreign Application Priority Data
Apr. 28, 2010 (JP) 2010-103147

(51) Int. Cl. G03G 15/08; G03G 21/00

(52) U.S. Cl. 399/53; 399/346

(57) ABSTRACT

An image forming apparatus includes: an image holder on which a toner image is formed; a developing device which is filled with a toner including a lubricant, and forms the toner image by making the toner adhere to the image holder; a torque calculation section which calculates torque of a drive motor which drives the image holder; a cleaning section which cleans the image holder; and a control section which calculates a print rate of the toner image formed on the image holder, makes determination of an adhering lubricant amount of the lubricant adhering to the image holder based on the print rate and the torque, and changes a toner image of a toner forcibly-discharging-pattern according to the determination.

### BACKGROUND OF THE INVENTION

1. Field of the Invention

The present invention relates to an image forming apparatus and a cleaning method.

2. Description of the Related Art

In an electrophotographic image forming apparatus, a cleaning blade or the like slides on the surface of an image holder (photosensitive drum, for example) so as to abut the surface thereof, thereby removing external matters such as the remaining toner adhering to the surface of the image holder (i.e. cleaning the surface of the image holder).

To clean the image holder by the cleaning blade or the like, a technology is used, the technology by which a toner to which a lubricant is added is applied to the surface of the image holder so that the lubricant adheres thereto, adhesive force of the toner to the image holder is reduced, and accordingly, cleaning performance of the image forming apparatus is improved.

It is also known that the amount of the lubricant adhering (adhering lubricant amount) to the surface of the image holder greatly influences the cleaning performance. For example, when the adhering lubricant amount to the surface of the image holder is short, the toner or the like easily adheres to the surface of the image holder. Consequently, it becomes difficult to clean the surface of the image holder. Accordingly, for example, the toner escapes cleaning of the image holder, and the edge part of the cleaning blade is pulled into a moving direction (rotation direction) of the image holder and turned up. On the other hand, when the adhering lubricant amount to the surface of the image holder is excessive, the surface of the image holder becomes a mirror surface. Consequently, the adhesiveness between the surface of the image holder and the edge part of the cleaning blade becomes high. Accordingly, the edge part of the cleaning blade is further pulled into the moving direction of the image holder, and hence, wear of the edge part of the cleaning blade progresses.

As a countermeasure against the shortage of a lubricant on the surface thereof, there is a technology by which the amount of a toner supplied to the surface thereof is adjusted in accordance with the magnitude of torque of a motor which drives the image holder.

For example, Japanese Patent Application Laid-open Publication No. 2000-172026 discloses a technology by which the width of a toner belt formed in a sheet gap is controlled by detecting a surface condition of an image holder by a torque change measurement section of a drive motor of the image holder, or by using chronological change data of the surface condition of the image holder. Furthermore, Japanese Patent Application Laid-open Publication No. 2007-108421 discloses a technology by which a drive torque reducing mode which increases the amount of a toner on an image holder is activated when a drive motor torque of the image holder exceeds a certain fixed value, the drive motor torque which is used to monitor the frictional force between the image holder and a cleaning blade.

However, the torque of a motor which drives an image holder increases both the times when the shortage of a lubricant on the surface of the image holder occurs and when the excessiveness of the lubricant thereon occurs. Therefore, for example, it could happen that although the adhering lubricant amount to the surface thereof is short, a lubricant is supplied to the image holder by using a toner pattern which makes it difficult to clean the image holder. In such a case, it raises a problem that a toner escapes the cleaning.

Furthermore, there is a technology using a toner as a polishing material to polish the surface of an image holder, the technology by which a toner is supplied to the surface of an image holder to remove the excessive lubricant on the surface thereof when the adhering lubricant amount to the surface thereof is excessive. However, it could happen that although the adhering lubricant amount thereto is excessive, a lubricant is supplied by using a toner pattern which makes it easy for the lubricant to adhere to the surface thereof. In such a case, it raises a problem that the adhering lubricant amount becomes more excessive. Accordingly, adhesive wear of a cleaning blade progresses, and hence, the cleaning blade is even broken.

Thus, it is difficult to determine whether the adhering lubricant amount is short or excessive based on only the magnitude of the torque of a motor which drives an image holder. Consequently, a toner pattern appropriate for the adhering lubricant amount cannot be selected, and hence, the shortage/excessiveness of the lubricant on the surface of the image holder cannot be solved.

That is, it is difficult to prevent poor cleaning of an image holder caused by the turn-up of a cleaning blade when the adhering lubricant amount is short, and to prevent poor cleaning thereof caused by the adhesive wear, which is resulted from decrease of the cleaning blade's capability of removing a lubricant, of a cleaning blade when the adhering lubricant amount is excessive.

### SUMMARY OF THE INVENTION

In view of the circumstances, a main object of the present invention is to provide a technology by which the amount of a lubricant adhering to the surface of an image holder is determined, and poor cleaning of the image holder which occurs depending on the amount of the lubricant adhering to the surface thereof is prevented from occurring.

In order to achieve at least one object mentioned above, according to a first aspect of the present invention, an image forming apparatus includes: an image holder on which a toner image is formed; a developing device which is filled with a toner including a lubricant, and forms the toner image by making the toner adhere to the image holder; a torque calculation section which calculates torque of a drive motor which drives the image holder; a cleaning section which cleans the image holder; and a control section which calculates a print rate of the toner image formed on the image holder, makes determination of an adhering lubricant amount of the lubricant adhering to the image holder based on the print rate and the torque, and changes a toner image of a toner forcibly-discharging-pattern according to the determination.

In order to achieve at least one object mentioned above, according to a second aspect of the present invention, a cleaning method of an image holder of an image forming apparatus having the image holder on which a toner image is formed, a developing device which is filled with a toner including a lubricant, and forms the toner image by making the toner adhere to the image holder, and a cleaning section which cleans the image holder, the cleaning method includes: calculating torque of a drive motor which drives the image holder; calculating a print rate of the toner image formed on the image holder; making determination of an adhering lubricant amount of the lubricant adhering to the image holder based on the print rate and the torque; and changing a toner image of a toner-forcibly-discharging pattern according to the determination.

### BRIEF DESCRIPTION OF THE DRAWINGS

The present invention will be understood fully from the detailed description given hereinbelow and the accompanying drawings, which are given by way of illustration only, and thus are not intended as a definition of the limits of the present invention, wherein:

FIG. 1 shows a structure of an image forming apparatus;

FIG. 2 is a schematic block diagram of an image forming unit of the image forming apparatus;

FIG. 3 is a functional block diagram of the image forming apparatus;

FIG. 4 is a graph showing a relationship between a print rate and a pure water contact angle;

FIG. 5 is a graph showing a relationship between the print rate and torque;

FIG. 6 is a flowchart of lubricant adjustment processing; and

FIG. 7 shows an evaluation result.

### DESCRIPTION OF THE PREFERRED EMBODIMENT

Hereinafter, an embodiment of the present invention is described in detail referring to the drawings.

First, the structure of an image forming apparatus according to an embodiment of the present invention is described.

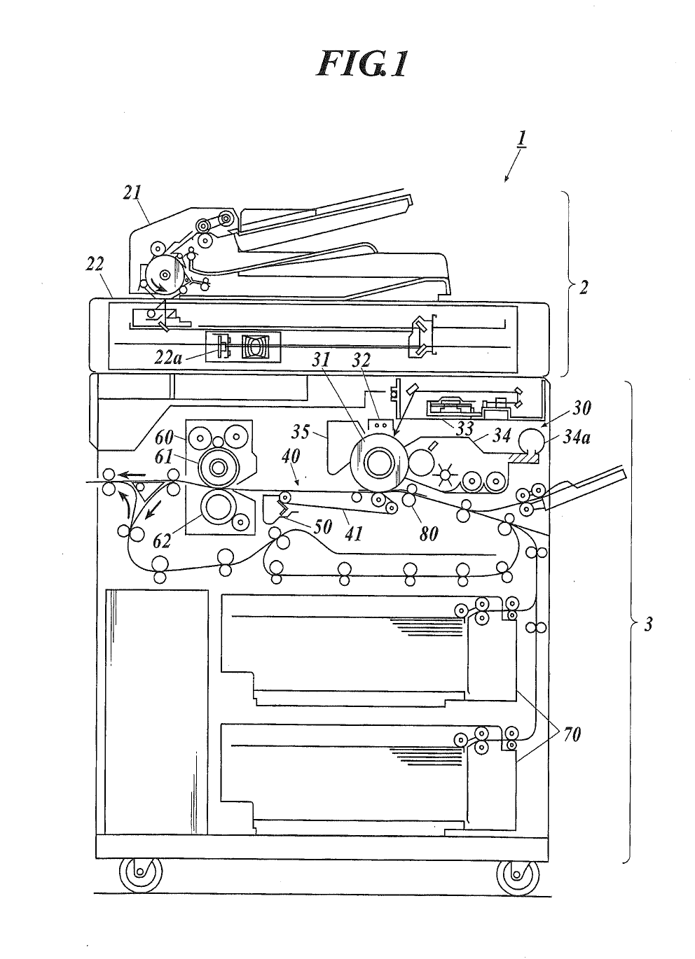

FIG. 1 shows the structure of an image forming apparatus according to an embodiment of the present invention.

An image forming apparatus 1 shown in FIG. 1 is a monochrome toner printer.

As shown in FIG. 1, the image forming apparatus 1 includes an image reading section 2 and a print section 3. The image reading section 2 includes an automatic document feeder 21 and a reading section 22. The print section 3 includes an image forming unit 30, a transfer unit 40, a cleaning unit 50, a fixation device 60, a paper feeding unit 70, and a register roller 80.

The automatic document feeder 21 is disposed at the upper part of the image forming apparatus 1. The automatic document feeder 21 includes a plurality of carrying rollers, thereby carrying a document placed on a document plate to a reading position of the reading section 22.

The reading section 22 is composed of a scanner or the like provided with a light source, a lens, a contact glass, an image sensor 22a, and the like. The reading section 22 performs photoelectrical conversion of an image formed by reflected light of light irradiating a document so as to read an image on the document, thereby generating an image signal (analog signal). It is noted that an image includes not only image data such as a figure and a picture but also text data such as a character and a symbol.

The image signal is converted into digital image data by an image processing section described below, and is temporarily stored in an image memory after various signal processing is performed thereon as needed. Thereafter, the image data is read from the image memory and outputted to the image forming unit 30.

The image forming unit 30 includes a photosensitive drum as an image holder, and also includes, around the photosensitive drum 31, a charging device 32, an exposing device 33, a developing device 34, and a cleaning section 35. The image forming unit 30 forms an image based on the image data.

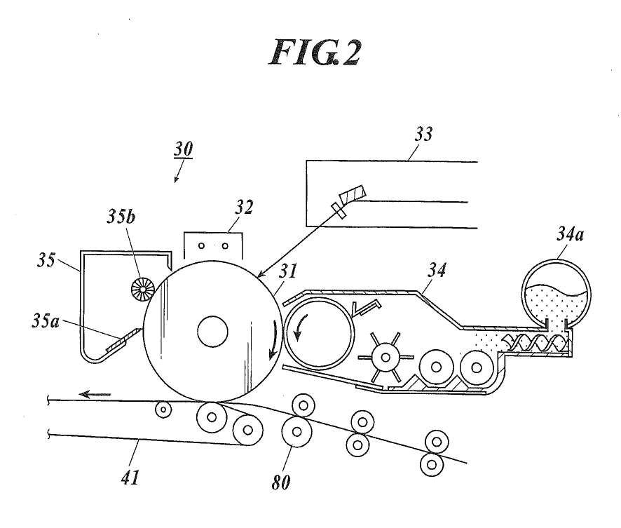

The image forming unit 30 is described below in detail referring to FIG. 2.

The transfer unit 40 transfers a toner image formed on the photosensitive drum 31 onto a sheet of paper carried by the register roller 80, and carries the sheet to the fixation device 60 thereafter.

The transfer unit 40 includes a transfer belt 41 which is tightly stretched by a plurality of rollers, and rotates thereby. The transfer belt 41 abuts the photosensitive drum 31, and functions as a transfer section which transfers a toner image formed on the photosensitive drum 31 to a sheet of paper.

In the embodiment, the transfer belt 41 is used as the transfer section, but this is not a limit. For example, a movable member (transfer roller, for example) which abuts the photosensitive drum 31 at a transferring position and moves in a sub-scanning direction (paper carrying direction) can be used as the transfer section.

The cleaning unit 50 scrapes a toner from the transfer belt 41 by a blade or the like so as to remove the toner, the toner which adheres to and remains on the transfer belt 41.

The fixation device 60 includes a fixation roller 61 having a heat source, and a pressure roller 62. A sheet carried to the fixation device 60 is heated and pressurized by the fixation roller 61 and the pressure roller 62, respectively, so as to undergo fixation processing. After the sheet undergoes the fixation processing, the sheet is ejected on a tray provided outside the image forming apparatus 1.

The paper feeding unit 70 includes a plurality of paper feeding cassettes, a manual-bypass tray, and paper feeding rollers. Standard-sized paper are accommodated in the paper feeding cassettes beforehand size by size and/or paper type by paper type. In order to meet users' needs, various sized paper including nonstandard-sized paper can be placed on the manual-bypass tray as needed.

The sheets of the paper accommodated in each of the paper feeding cassettes or on the manual-bypass tray are carried to the register roller 80 one by one from the top, and then carried to the transferring position of the transfer belt 41 of the transfer unit 40 and the photosensitive drum 31 by the register roller 80. Although a toner image is transferred onto a sheet by the transfer unit 40 and the photosensitive drum 31, a timing of the sheet entering into the transferring position is controlled by the register roller 80. The register roller 80 controls the timing in such a way that the timing of the sheet entering into the transferring position is synchronized with a timing of the toner image moving into the transferring position, the toner image which is moved by rotation of the photosensitive drum 31.

FIG. 2 is a schematic block diagram of the image forming unit 30 according to the embodiment of the present invention.

The photosensitive drum 31 is connected to a drive mechanism such as a drive motor, and rotates by the drive motor at a fixed speed. The charging device 32 charges the photosensitive drum 31 so that the surface of the photosensitive drum 31 has a predetermined polarity (negative polarity, for example).

The exposing device 33 exposes the surface of the photosensitive drum 33 to light according to the image data so as to form an electrostatic latent image.

The developing device 34 includes a toner supply device 34a filled with a toner to which a lubricant is added. The developing device 34 develops the electrostatic latent image by supplying the toner to the surface of the photosensitive drum 31 so that the toner adheres thereto, thereby forming a toner image on the photosensitive drum 31 moving at the fixed speed. The toner is charged to have a predetermined polarity (negative polarity, for example) beforehand. The photosensitive drum 31 rotates at the fixed speed, so that the toner image formed on the photosensitive drum 31 by the developing device 34 moves to the transferring position at the fixed speed, and the toner image is transferred to a sheet at the transferring position.

A lubricant is added to the toner with which the toner supply device 34a is filled so as to facilitate lubricity of the surface of the toner. Consequently, the toner adhering to the surface of the photosensitive drum 31 is easily torn, and accordingly, cleaning performance of the image forming apparatus 1 is ensured.

The lubricant has a polarity (positive polarity, for example) opposite to the polarity of the toner so as to easily adhere to the toner. The lubricant moves to the surface of the photosensitive drum 31 with the toner at the time of developing an electrostatic image. Much toner moves to an unexposed part (a part charged to be negative) of the surface of the photosensitive drum 31. It is preferable to use a lubricant containing hydrophobic material such as zinc stearate, calcium stearate, or magnesium stearate as a principal ingredient.

When a toner image is formed on the photosensitive drum 31, the lubricant added to the toner moves to the surface of the photosensitive drum 31. Hence, the developing device 34 has a function to supply a lubricant to the surface of the photosensitive drum 31 so that the lubricant adheres thereto.

The toner supply device 34a includes a toner bottle which is capable of storing a large amount of a toner and a connector which connects the toner bottle to the developing device 34.

An outlet of the toner bottle, the outlet from which a toner is discharged, is attached to the connector so as to be detachable from the connector. The connector includes a cylindrical body connecting the outlet of the toner bottle to the inside of the developing device 34, and a screw member provided in the cylindrical body. The connector makes the toner, which is discharged from the toner bottle, flow into the developing device 34 in accordance with the rotation of the screw member. The screw member is driven by a toner supply motor of the toner supply device 34a (not shown).

The cleaning section 35 includes a cleaning blade 35a and a cleaning brush 35b, and removes a toner or the like adhering to the surface of the photosensitive drum 31. One end part of the cleaning blade 35a slides on the surface of the photosensitive drum 31 so as to abut the surface thereof. The toner adhering to the surface of the photosensitive drum 31 is directly and physically torn and scraped by the one end part so as to be removed.

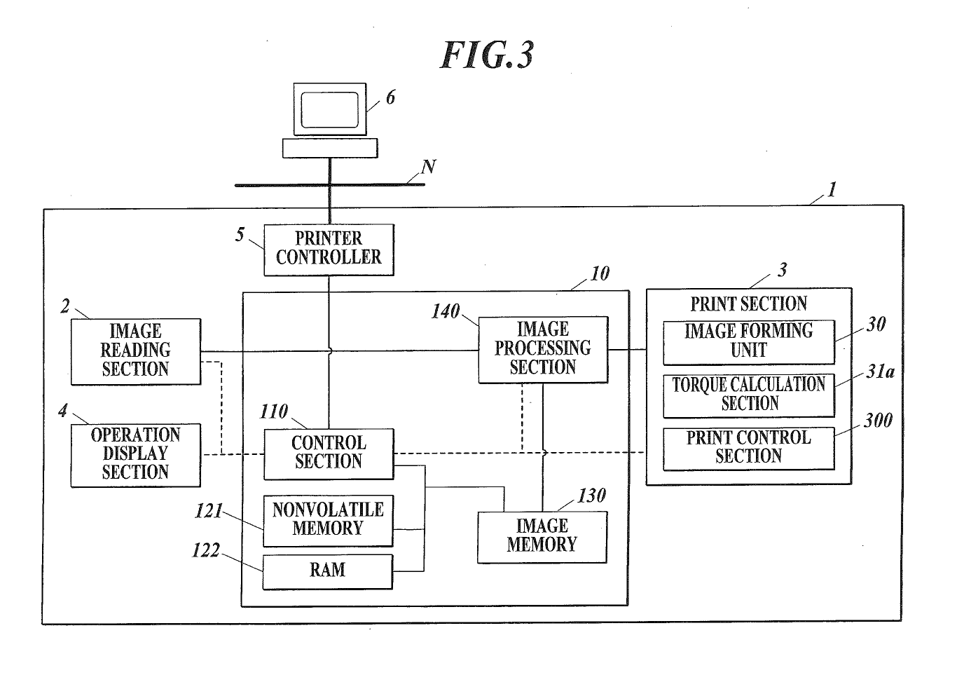

FIG. 3 is a functional block diagram of the image forming apparatus 1 according to the embodiment of the present invention.

As shown in FIG. 3, the image forming apparatus 1 includes the image reading section 2, the print section 3, an operation display section 4, a printer controller 5, and a main-body control section 10.

The image reading section 2 includes the automatic document feeder 21 and the reading section 22, which are shown in FIG. 1, and an image reading control section. The image reading control section controls the automatic document feeder 21, the reading section 22, and the like to perform exposure scanning on a document, and allows the image sensor 22a to photoelectrically convert reflected light of light so as to read an image on the document. Data of the read image is outputted to an image processing section 140.

The print section 3 includes the image forming unit 30, the transfer unit 40, the cleaning unit 50, the fixation device 60, the paper feeding unit 70, the register roller 80, and the like, which are shown in FIG. 1, and a torque calculation section 31a, components relating to printing, and a print control section 300.

The torque calculation section 31a detects a drive current value based on which the drive motor driving the photosensitive drum 31 is controlled. The torque calculation section 31a calculates torque of the photosensitive drum 31 based on the drive current value, and outputs the calculated torque to a control section 110 (described below) provided in the main-body control section 10.

It is not necessary that the torque calculation section 31a is configured to calculate the torque based on a drive current value of the drive motor which drives the photosensitive drum 31. For example, the torque calculation section 31a may be a strain gauge type, a magnetostrictive effect type, a phase difference detection type, or a mechanical reaction force type using a coil spring or the like.

The print control section 300 controls each component of the print section 3 according to an instruction from the control section 110 to form an image based on the image data inputted from the image processing section 140.

The operation display section 4 includes a liquid crystal display (LCD), an electro-luminescence (EL) display, a touch panel, an operation key set including various keys, and an operation display control section. The operation display control section allows the LCD and/or the EL display to display each of various screens used for inputting various settings, various processing results, and the like according to a display signal inputted from the control section 110. In addition, the operation display control section outputs an operation signal inputted from the operation key set or the touch panel to the control section 110.

When the image forming apparatus 1 is used as a network printer, the printer controller 5 manages and controls a job transmitted to the image forming apparatus 1 from an external device 6 such as a personal computer (PC) connected to a network N such as a local area network (LAN). The printer controller 5 receives data to be printed from the external device 6, and outputs the data as job information to the control section 110.

The main-body control section 10 includes the control section 110, a nonvolatile memory 121, a random access memory (RAM) 122, an image memory 130, and the image processing section 140. Each component of the main-body control section 10 is controlled by the control section 110.

The control section 110 is composed of a central processing unit (CPU) or the like. The control section 110 reads a specific program and/or data from among a system program, various application programs, and various data which are stored in the nonvolatile memory 121, expands the read program in the RAM 122, and performs each of various processing in cooperation with the program expanded in the RAM 122, so as to perform centralized control of the image forming apparatus 1. For example, the control section 110 controls copying, printing, and image data reading by changing modes among a copy mode, a print mode, and a scan mode in response to an instruction signal inputted from the external device 6 connected to the image forming apparatus 1 via the operation display section 4 or the printer controller 5.

The control section 110 reads, from the nonvolatile memory 121, a program of lubricant adjustment processing according to the embodiment of the present invention and various data necessary for the lubricant adjustment processing, and performs the lubricant adjustment processing in cooperation with the program and the data, the lubricant adjustment processing by which the amount of a lubricant adhering (adhering lubricant amount) to the surface of the photosensitive drum 31 is adjusted.

In the lubricant adjustment processing according to the embodiment of the present invention, the control section 110 obtains the torque calculated by the torque calculation section 31a each time print processing is performed. When the calculated torque (torque) is more than a preset value (threshold toque), a print rate is calculated, the print rate which is the average of print rates (average print rate) during a prescribed period of time. Then, the adhering lubricant amount to the photosensitive drum 31 is determined based on the print rate and the torque.

In the lubricant adjustment processing according to the embodiment of the present invention, when the torque is more than the threshold toque, and the print rate is more than a preset standard print rate, it is determined that the adhering lubricant amount to the photosensitive drum 31 is excessive. On the other hand, when the torque is more than the threshold toque, and the print rate is equal to the standard print rate or less, it is determined that the adhering lubricant amount to the photosensitive drum 31 is short.

Furthermore, in the lubricant adjustment processing according to the embodiment of the present invention, a pattern for forcibly discharging a toner (toner-forcibly-discharging pattern), the pattern of which a toner image is formed in a no-image forming region, is changed between the time when the adhering lubricant amount to the photosensitive drum 31 is excessive and the time when the adhering lubricant amount thereto is short. When the adhering lubricant amount thereto is excessive, a toner image of a first toner-forcibly-discharging pattern is formed in the no-image forming region of the photosensitive drum 31. On the other hand, when the adhering lubricant amount thereto is short, a toner image of a second toner-forcibly-discharging pattern is formed in the no-image forming region of the photosensitive drum 31.

The no-image forming region of the photosensitive drum 31 is a region between image regions in each of which a toner image/toner images to be transferred to one sheet is/are formed. The no-image forming region is referred to as a “sheet gap”, in general.

The toner images of the first and the second toner-forcibly-discharging patterns become different from each other by making the amount of a toner per unit area of the toner images and/or the form of the toner images different from each other. The amount of the toner per unit area of the toner image of the first toner-forcibly-discharging pattern is more than the amount of the toner per unit area of the toner image of the second toner-forcibly-discharging pattern.

It is preferable that the toner image of the first toner-forcibly-discharging pattern be, for example, a belt-shaped solidly-black toner image (solid pattern) which is made of only black pixels, has the maximum density printable by the image forming apparatus 1, and extends in a main-scanning direction.

It is preferable that the toner image of the second toner-forcibly-discharging pattern be, for example, a stripe-shaped toner image (line pattern) which is composed of a plurality of belt-shaped images made of black pixels (black belt images) and a plurality of belt-shaped images made of white pixels (white belt images) being alternately arranged.

The toner image of the second toner-forcibly-discharging pattern may be a belt-shaped toner image (half-tone solid pattern) which has the amount of the toner per unit area being less than the amount of the toner per unit area of the toner image of the second toner-forcibly-discharging pattern, namely, which has a density (50%, for example) lower than the maximum density printable by the image forming apparatus 1, and extends in the main-scanning direction.

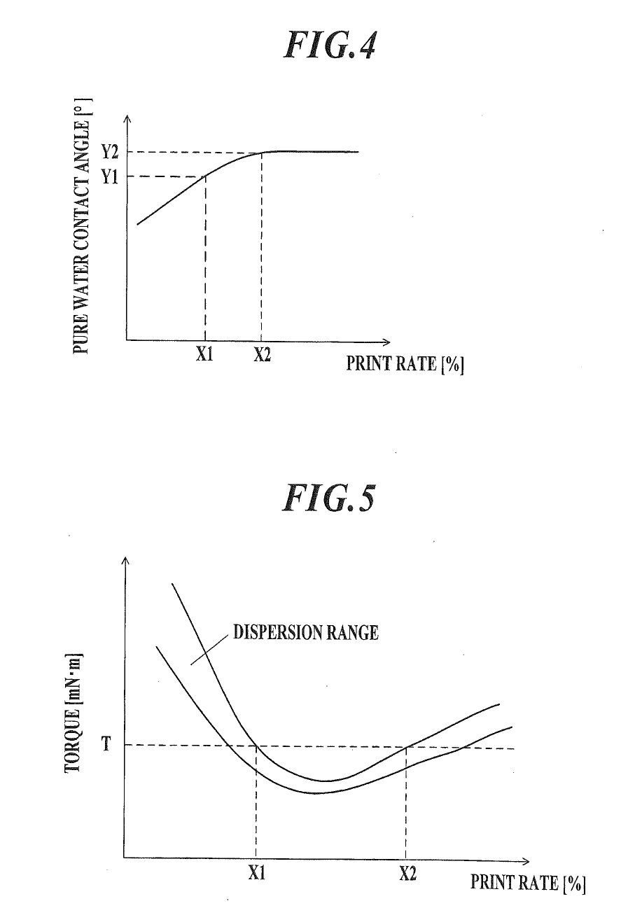

FIG. 4 is a graph showing a relationship between the print rate and a pure water contact angle, and FIG. 5 is a graph showing a relationship between the print rate and the torque. Referring to FIGS. 4 and 5, the threshold torque and the standard print rate are described. A region between two curved lines in FIG. 5 shows a range (dispersion range) of dispersion data of the torque calculated by the torque calculation section 31a.

The graph in FIG. 4 shows the relationship of the pure water contact angle on the surface of the photosensitive drum 31 to the print rate during a prescribed period of time according to the embodiment of the present invention.

As shown in FIG. 4, when the print rate is X1% or less, the pure water contact angle on the surface of the photosensitive drum 31 is small. That is, the adhering lubricant amount to the surface thereof is less than a proper amount (the adhering lubricant amount is short), and poor cleaning of the photosensitive drum 31 occurs accordingly.

On the other hand, when the print rate is X2% or more, the pure water contact angle on the surface of the photosensitive drum 31 keeps a large value and is nearly uniform. That is, the adhering lubricant amount to the surface thereof is more than the proper amount (the adhering lubricant amount is excessive), and accordingly, the surface of the photosensitive drum 31 becomes a mirror surface. That is, when the print rate is X2% or more, adhesive wear of the cleaning blade 35a and the photosensitive drum 31 progresses, and the poor cleaning occurs accordingly.

Therefore, a print rate range from X1% to X2% can be set as a proper print rate range which does not cause the poor cleaning, so that the standard print rate can be determined within the range. The print rates of X1% and X2% change depending on the material of the photosensitive drum 31, the composition of the lubricant, and/or the composition of the toner.

As shown in FIG. 5, the torque increases while the print rate is low (X1% or less, for example) or while the print rate is high (X2% or more, for example). That is, when the print rate is low (the adhering lubricant amount is short) and when the print rate is high (the adhering lubricant amount is excessive), the torque becomes equal to a prescribed value or more.

When X1% and X2% of the print rate shown in FIG. 5 correspond to X1% and X2% of the print rate shown in FIG. 4, respectively, the torque for the print rate of X1% to X2% does not cause the poor cleaning. Therefore, any value of the torque for the print rate of X1% to X2% can be set as the threshold torque.

The nonvolatile memory 121 stores various processing programs relating to image formation, data thereof, the program of the lubricant adjustment processing according to the embodiment of the present invention, tables and data necessary for executing the program of the lubricant adjustment processing, data processed by various programs, and the like.

The RAM 122 forms a work area where the various programs executed by the control section 110, various data of the programs, and the like are temporarily stored.

The image memory 130 is composed of a hard disk drive (HDD), a dynamic RAM (DRAM), or the like, and stores image data in such a way that the image data is readable and rewritable. According to an instruction from the control section 110, the image data inputted from the image reading section 2 or the printer controller 5 is stored/saved in the image memory 130, the image data stored in the image memory 130 is read so as to be outputted to the image processing section 140, or the like.

The image processing section 140 performs various image processing such as screen processing on the image data inputted from the image reading section 2, the printer controller 5, or the image memory 130, and outputs the data to the control section 110 or the image memory 130. The image processing section 140 converts an analog image signal inputted from the image reading section 2 into digital image data, compresses the digital image data so as to be outputted to the image memory 130, and/or decompresses the compressed image data so as to be outputted, for example.

Next, an operation of the image forming apparatus 1 according to the embodiment of the present invention is described.

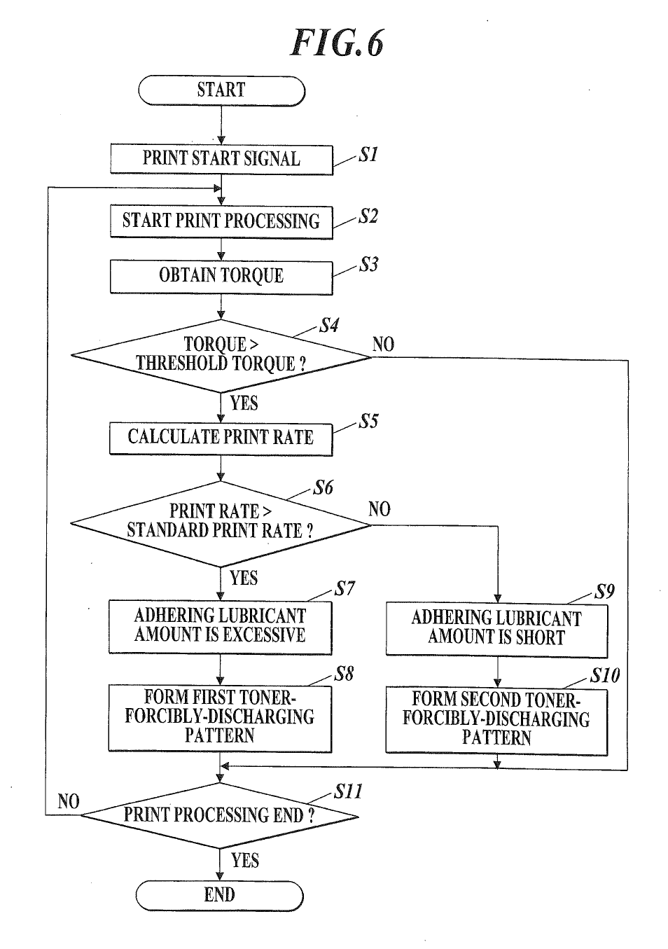

FIG. 6 is a flowchart of the lubricant adjustment processing according to the embodiment of the present invention.

The lubricant adjustment processing shown in FIG. 6 is performed by the control section 110 and each component of the image forming apparatus 1 working together.

When a print start signal which instructs to perform print processing is inputted from the operation display section 4 or the external device 6 (Step S1), the control section 110 allows each component of the print section 3 to start the print processing for one page based on image data (Step S2), and obtains the torque of the photosensitive drum 31 inputted from the torque calculation section 31a (Step S3).

The torque obtained at Step S3 is the torque calculated by the torque calculation section 31a before a toner image is formed based on the image data for one page.

The control section 110 determines whether the torque is more than a threshold torque T or not (Step S4). When it is determined that the torque is equal to the threshold torque T or less (Step S4; NO), the control section 110 does not form a toner image of a toner-forcibly-discharging pattern, and moves to Step S11.

When it is determined that the torque is more than the threshold torque T (Step S4; YES), the control section 110 calculates a print rate (Step S5).

At Step S5, an average print rate during a prescribed period of time (while the print processing is performed 100 times, for example) is calculated as the print rate. The print rate is calculated, for example, from the area of an image forming region and the area of a part of the image forming region, the part where dots (pixels) are formed, during the prescribed period of time.

The control section 110 determines whether the print rate calculated at Step S5 is more than a standard print rate or not (Step S6).

When it is determined that the print rate is more than the standard print rate (Step S6; YES), the control section 110 determines that the adhering lubricant amount to the surface of the photosensitive drum 31 is excessive (Step S7), and makes a toner image of the first toner-forcibly-discharging pattern formed in a sheet gap (Step S8).

In accordance with an instruction from the control section 110, the print section 3 forms the toner image of the first toner-forcibly-discharging pattern in the sheet gap. Consequently, when the toner image of the first toner-forcibly-discharging pattern formed in the sheet gap is removed by the cleaning section 35, namely, when the photosensitive drum 31 is cleaned, the lubricant adhering to the surface of the photosensitive drum 31 is removed with the toner image.

When it is determined that the print rate is equal to the standard print rate or less (Step S6; NO), the control section 110 determines that the adhering lubricant amount to the surface of the photosensitive drum 31 is short (Step S9), and makes a toner image of the second toner-forcibly-discharging pattern formed in the sheet gap (Step S10).

In accordance with an instruction from the control section 110, the print section 3 forms the toner image of the second toner-forcibly-discharging pattern in the sheet gap. Since the toner image of the second toner-forcibly-discharging pattern is formed on the surface of the photosensitive drum 31, the lubricant added to the toner of the toner image moves to the surface of the photosensitive drum 31 too.

In the case where the toner image of the first or the second toner-forcibly-discharging pattern is formed, the transfer belt 41 is separated from the photosensitive drum 31 at the transferring position while the toner image of the first or the second toner-forcibly-discharging pattern is passing through the transferring position.

The control section 110 determines whether the print processing is ended or not after Step S4; NO, Step S8, and Step S10 (Step S11). When it is determined that the print processing is not ended (Step S11; NO), the control section 110 returns to Step S2. When it is determined that the print processing is ended (Step S11; YES), the control section 110 ends the lubricant adjustment processing.

Application of the image forming apparatus 1 according to the embodiment of the present invention to the poor cleaning of the photosensitive drum 31 was evaluated.

For the evaluation, the threshold torque was set to 300 mN·m, the standard print rate was set to 12%, and the second toner-forcibly-discharging pattern was made to be different for each evaluation model.

The evaluation was made from the following points: whether a toner escapes cleaning performed by the cleaning blade 35a of the cleaning section 35; and whether the torque of the photosensitive drum 31 changes between before and after forming a toner image of the first or the second toner-forcibly-discharging pattern so as to decrease after forming the toner image thereof.

As comparative examples, cases were evaluated, the cases where a toner image of a toner-forcibly-discharging pattern was formed in a sheet gap regardless of the torque and the print rate.

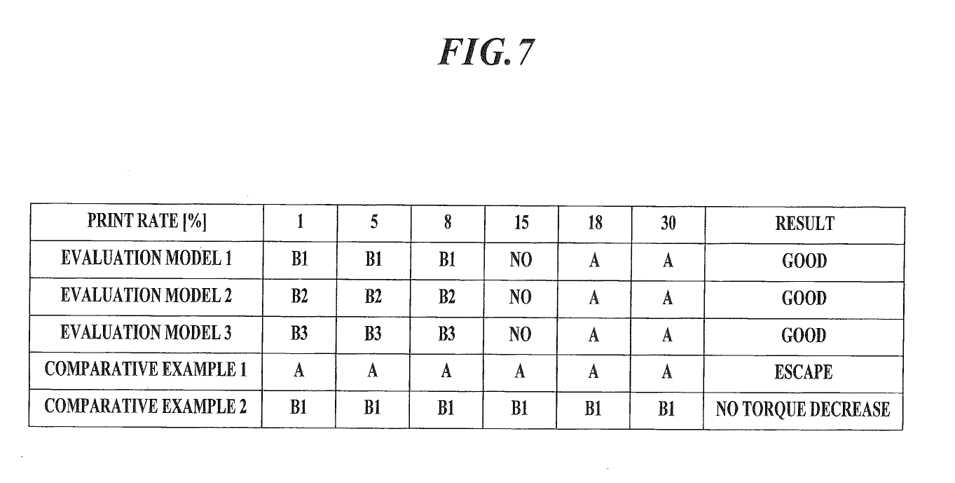

FIG. 7 shows the evaluation result.

In evaluation models 1 to 3 shown in FIG. 7, a toner-forcibly-discharging pattern was changed depending on the torque and the print rate. In comparative examples 1 and 2, a toner image of a toner-forcibly-discharging pattern was formed regardless of the torque and the print rate.

The “A” shown in FIG. 7 represents the first toner-forcibly-discharging pattern, and the “B1”, “B2”, and “B3” represent the second toner-forcibly-discharging pattern.

The “A” is a solid pattern having the maximum density printable by the image forming apparatus 1, and a length of 20 mm in the sub-scanning direction. The “B1” is a line pattern having the maximum density printable by the image forming apparatus 1, and a length of 40 mm in the sub-scanning direction.

The “B2” is a solid pattern having a density of 50% of the maximum density printable by the image forming apparatus 1, and a length of 40 mm in the sub-scanning direction. The “B3” is a line pattern having a density of 50% of the maximum density printable by the image forming apparatus 1, and a length of 80 mm in the sub-scanning direction.

In the evaluation models 1 to 3, when the print rate was equal to the standard print rate or less (1%, 5%, and 8% in FIG. 7), toner images of B1, B2, B3 were formed, respectively, as a toner image of the second toner-forcibly-discharging pattern. When the print rate was more than the standard print rate (18% and 30% in FIG. 7), a toner image of A was formed as a toner image of the first toner-forcibly-discharging pattern.

When the print rate was 15%, the torque was equal to the threshold torque or less, so that a toner image of a toner-forcibly-discharging pattern was not formed.

In the evaluation models 1 to 3, the toner did not escape the cleaning, and the torque after forming a toner image of a toner-forcibly-discharging pattern decreased as compared with the torque before forming the toner image thereof so as to be within a proper range of the torque. That is, the poor cleaning did not occur, and hence, the evaluation models 1 to 3 were evaluated as good.

On the other hand, in the comparative example 1 shown in FIG. 7, the toner image of A of the first toner-forcibly-discharging pattern was formed in the sheet gap regardless of the torque and the print rate.

In the comparative example 1, when the print rate was low (1% and 5%, for example), the toner escaped the cleaning. Accordingly, there is possibility that the toner escaping the cleaning adheres to a sheet, and hence, the quality of an image on the sheet declines.

In the comparative example 2 shown in FIG. 7, the toner image of B1 of the second toner-forcibly-discharging pattern was formed in the sheet gap regardless of the torque and the print rate.

In the comparative example 2, when the print rate was high (18% and 30%, for example), the torque after forming the toner image thereof did not decrease. Accordingly, there is possibility that the wear of the cleaning blade 35a and the photosensitive drum 31 progresses, and hence, the cleaning blade 35a is broken.

As described above, according to the embodiment of the present invention, the adhering lubricant amount to the surface of the photosensitive drum 31 can be determined based on a print rate of a toner image formed on the photosensitive drum 31 and the torque of the photosensitive drum 31 calculated by the torque calculation section 31a, and a toner image of a toner-forcibly-discharging pattern to be formed in a sheet gap can be changed according to the determination. That is, the adhering lubricant amount to the surface of the photosensitive drum 31 can be determined based on the print data and the torque, and hence, the poor cleaning which occurs depending on the adhering lubricant amount can be prevented from occurring.

Furthermore, when the torque is more than a threshold torque, and the print rate is more than a standard print rate, it can be determined that the adhering lubricant amount to the surface of the photosensitive drum 31 is excessive. That is, when the adhering lubricant amount to the photosensitive drum is excessive, a toner image of the first toner-forcibly-discharging pattern can be formed to solve the excessiveness of the lubricant on the photosensitive drum 31. Consequently, when the toner of the toner image thereof is removed by the cleaning section 35, the excessive lubricant is removed too, and hence, the excessiveness of the lubricant on the photosensitive drum 31 can be solved. Consequently, the poor cleaning can be prevented from occurring.

Furthermore, when the torque is more than the threshold torque, and the print rate is equal to the standard print rate or less, it can be determined that the adhering lubricant amount to the surface of the photosensitive drum 31 is short. That is, when the adhering lubricant amount to the photosensitive drum is short, a toner image of the second toner-forcibly-discharging pattern can be formed to solve the shortage of the lubricant on the photosensitive drum 31. Consequently, the lubricant added to the toner of the toner image thereof moves to the photosensitive drum 31, and hence, the shortage of the lubricant on the photosensitive drum 31 can be solved. Consequently, the poor cleaning can be prevented from occurring.

The control section 110 can change the amount of a toner per unit area of a toner image of a toner-forcibly-discharging pattern, and the form of the toner image, so as to make toner images of the first and second forcibly-discharging patterns different from each other.

As the lubricant, a lubricant containing at least one of zinc stearate, calcium stearate, and magnesium stearate as a principal ingredient can be used.

In the above, as a computer readable medium of a program of the present invention, the nonvolatile memory 121 is used. However, this is not a limit.

As another computer readable medium, a nonvolatile memory such as a flash memory and a portable recording medium such as a CD-ROM can be used.

Furthermore, as a medium to provide data of the program of the present invention via a communication line, a carrier wave can be used.

The present invention is not limited to the embodiment described above, and hence can be appropriately modified without departing from the scope of the present invention. For example, an image forming apparatus can be used, the image forming apparatus which includes a plurality of image forming units for colors such as yellow (Y), magenta (M), cyan (C), and black (K), and transfers toner images of the colors formed by their respective image forming units in such a way that the toner images are superposed, thereby forming a color image on a sheet.

According to a first aspect of the embodiment of the present invention, there is provided an image forming apparatus including: an image holder on which a toner image is formed; a developing device which is filled with a toner including a lubricant, and forms the toner image by making the toner adhere to the image holder; a torque calculation section which calculates torque of a drive motor which drives the image holder; a cleaning section which cleans the image holder; and a control section which calculates a print rate of the toner image formed on the image holder, makes determination of an adhering lubricant amount of the lubricant adhering to the image holder based on the print rate and the torque, and changes a toner image of a toner forcibly-discharging-pattern according to the determination.

According to a second aspect of the embodiment of the present invention, there is provided a cleaning method of an image holder of an image forming apparatus having the image holder on which a toner image is formed, a developing device which is filled with a toner including a lubricant, and forms the toner image by making the toner adhere to the image holder, and a cleaning section which cleans the image holder, the cleaning method including: calculating torque of a drive motor which drives the image holder; calculating a print rate of the toner image formed on the image holder; making determination of an adhering lubricant amount of the lubricant adhering to the image holder based on the print rate and the torque; and changing a toner image of a toner-forcibly-discharging pattern according to the determination.

According to the image forming apparatus and the cleaning method, the adhering lubricant amount to the image holder can be determined based on the print rate and the torque, so that the poor cleaning which occurs depending on the adhering lubricant amount can be prevented from occurring.

Preferably, when the torque is more than a preset threshold torque, and the print rate is more than a preset standard print rate, the control section makes the determination that the adhering lubricant amount to the image holder is excessive.

Accordingly, when the torque is more than a preset threshold torque, and the print rate is more than a preset standard print rate, it can be determined that the adhering lubricant amount to the image holder is excessive.

Preferably, when the torque is more than a preset threshold torque, and the print rate is equal to a preset standard print rate or less, the control section makes the determination that the lubricant on the image holder is short.

Accordingly, when the torque is more than a preset threshold torque, and the print rate is equal to a preset standard print rate or less, it can be determined that the adhering lubricant amount to the image holder is short.

Preferably, the control section changes an amount of the toner per unit area of the toner image of the toner-forcibly-discharging pattern according to the determination so as to change the toner image of the toner-forcibly-discharging pattern.

Accordingly, by changing an amount of the toner per unit area of the toner image of the toner-forcibly-discharging pattern according to the determination, the toner image of the toner-forcibly-discharging pattern can be changed.

Preferably, the control section changes a form of the toner image of the toner-forcibly-discharging pattern according to the determination so as to change the toner image of the toner-forcibly-discharging pattern.

Accordingly, by changing a form of the toner image of the toner-forcibly-discharging pattern according to the determination, the toner image of the toner-forcibly-discharging pattern can be changed.

Preferably, the torque calculation section detects a drive current value of the drive motor, and outputs the torque calculated based on the drive current value.

Accordingly, the torque calculated based on the drive current value of the drive motor which drives the image holder can be used.

Preferably, the lubricant contains zinc stearate.

Accordingly, the lubricant containing zinc stearate can be used.

Preferably, the lubricant contains calcium stearate.

Accordingly, the lubricant containing calcium stearate can be used.

Preferably, the lubricant contains magnesium stearate.

Accordingly, the lubricant containing magnesium stearate can be used.

The present U.S. patent application claims priority from Japanese Patent Application No. 2010-103147 filed with Japan Patent Office on Apr. 28, 2010, under the Paris Convention for the Protection of Industrial Property, and the Japanese Patent Application is a ground for correction of mistakes in translation of the present U.S. patent application.

What is claimed is:

1. An image forming apparatus comprising:
an image holder on which a toner image is formed;
a developing device which is filled with a toner including a lubricant, and forms the toner image by making the toner adhere to the image holder;
a torque calculation section which calculates torque of a drive motor which drives the image holder;
a cleaning section which cleans the image holder; and
a control section which calculates a print rate of the toner image formed on the image holder, makes determination of an adhering lubricant amount of the lubricant adhering to the image holder based on the print rate and the torque, and changes a toner image of a toner forcibly-discharging-pattern according to the determination.

2. The image forming apparatus according to claim 1, wherein when the torque is more than a preset threshold torque, and the print rate is more than a preset standard print rate, the control section makes the determination that the adhering lubricant amount to the image holder is excessive.

3. The image forming apparatus according to claim 1, wherein when the torque is more than a preset threshold torque, and the print rate is equal to a preset standard print rate or less, the control section makes the determination that the lubricant on the image holder is short.

4. The image forming apparatus according to claim 1, wherein the control section changes an amount of the toner per unit area of the toner image of the toner-forcibly-discharging pattern according to the determination so as to change the toner image of the toner-forcibly-discharging pattern.

5. The image forming apparatus according to claim 1, wherein the control section changes a form of the toner image of the toner-forcibly-discharging pattern according to the determination so as to change the toner image of the toner-forcibly-discharging pattern.

6. The image forming apparatus according to claim 1 wherein the torque calculation section detects a drive current value of the drive motor, and outputs the torque calculated based on the drive current value.

7. The image forming apparatus according to claim 1, wherein the lubricant contains zinc stearate.

8. The image forming apparatus according to claim 1, wherein the lubricant contains calcium stearate.

9. The image forming apparatus according to claim 1, wherein the lubricant contains magnesium stearate.

10. A cleaning method of an image holder of an image forming apparatus having the image holder on which a toner image is formed, a developing device which is filled with a toner including a lubricant, and forms the toner image by making the toner adhere to the image holder, and a cleaning section which cleans the image holder, the cleaning method comprising:
calculating torque of a drive motor which drives the image holder;
calculating a print rate of the toner image formed on the image holder;
making determination of an adhering lubricant amount of the lubricant adhering to the image holder based on the print rate and the torque; and
changing a toner image of a toner-forcibly-discharging pattern according to the determination.
